(19) United States
(12) Patent Application Publication
(10) Pub. No.: US 2019/0033680 A1
(43) Pub. Date: Jan. 31, 2019

(54) WEARABLE DEVICE

(71) Applicant: SEIKO EPSON CORPORATION, Tokyo (JP)

(72) Inventor: Noriaki HIRAIDE, Shiojiri-shi (JP)

(73) Assignee: SEIKO EPSON CORPORATION, Tokyo (JP)

(21) Appl. No.: 16/034,766

(22) Filed: Jul. 13, 2018

(30) Foreign Application Priority Data
Jul. 28, 2017 (JP) 2017-146424

(51) Int. Cl. G02F 1/167; G02F 1/1333; G06F 1/16; G02F 1/01

(52) U.S. Cl. CPC G02F 1/167; G02F 1/0107; G06F 1/163; G02F 1/133305

(57) ABSTRACT

A front light includes a first diffusing section and a second diffusing section. The first diffusing section is an annular member that diffuses light emitted from an LED. The inner circumferential surface of the first diffusing section has higher surface roughness than the other surfaces among a plurality of surfaces of the first diffusing section. Because the first diffusing section is annular, the light emitted from the LED revolves while reflecting in the first diffusing section and is uniformized in the first diffusing section. On the inner circumferential surface of the first diffusing section, because the surface roughness is higher than the surface roughness of the other surfaces, reflected lights decrease and refracted lights increase. The refracted light is guided to the second diffusing section. In this way, the light emitted from the Led is guided to the second diffusing section after being uniformized in the first diffusing section.

### CROSS-REFERENCES TO RELATED APPLICATIONS

This application claims priority to Japanese Patent Application No. 2017-146424, filed Jul. 28, 2017, the entirety of which is herein incorporated by reference.

### BACKGROUND

### 1. Technical Field

The present invention relates to a wearable device.

### 2. Related Art

In recent years, wearable devices carried and used by users have been spread. A wearable device including a display includes a front light to thereby sometimes improve visibility even in a dark environment. For example, JP-A-2010-231000 (Patent Literature 1) discloses an electrophoretic display device as a device including a front light. The electrophoretic display device is configured such that light emitted from the front light irradiates a display surface. The front light includes a transparent light guide plate. A light source is disposed at an end portion of the transparent light guide plate.

However, in the device including the front light in the past, because the light source is provided on the end side of the transparent light guide plate, the luminance of the light irradiated on the transparent light guide plate is larger in a place closer to the light source and is smaller in a place farther from the light source. Therefore, luminance unevenness occurs on the display surface.

### SUMMARY

An advantage of some aspects of the invention is to prevent luminance unevenness of a display section of a wearable device from easily occurring.

A wearable device according to an aspect of the invention includes: a light source; a display section; an annular first diffusing section configured to diffuse light emitted from the light source; a second diffusing section located on an inside of a ring of the first diffusing section and configured to irradiate the light diffused by the first diffusing section on the display section; and a case section configured to house the light source, the display section, the first diffusing section, and the second diffusing section. A surface opposed to the second diffusing section among a plurality of surfaces forming the first diffusing section has higher surface roughness than other surfaces among the plurality of surfaces.

In the aspect of the invention, because the first diffusing section is annular, the light emitted from the light source revolves while reflecting in the first diffusing section and is uniformized in the first diffusing section. Because the surface roughness of the inner circumferential surface of the first diffusing section is higher than the surface roughness of the other surface, on the inner circumferential surface of the first diffusing section, reflected lights decrease and refracted lights increase more than on the other surfaces. The refracted light is guided to the second diffusing section. With such structure of the first diffusing section, the light emitted from the light source is guided to the second diffusing section after being uniformized in the first diffusing section without being directly guided to the second diffusing section. Therefore, it is possible to prevent luminance unevenness of the display section from easily occurring. The “annular” may be any shape as long as a ring is closed. Therefore, when the shape of the inner circumference and the outer circumference of the first diffusing section is a square, the shape is included in the “annular”.

In the aspect of the invention, it is preferable that the display section has a flat shape, and, in a cross-sectional view of the light source, the display section, and the first diffusing section from a direction orthogonal to a normal direction of the display section, the display section is located between the first diffusing section and the light source.

According to the aspect with this configuration, compared with when the first diffusing section, the second diffusing section, and the light source are present on the same plane, it is possible to further increase a display region of the display section in size without increasing the wearable device in size in a side surface direction of the display section.

In the aspect of the invention, it is preferable that the wearable device includes a light guide section configured to guide the light emitted from the light source to the first diffusing section.

According to the aspect with this configuration, use of the light guide section makes it unnecessary to dispose the light source on a plane including the first diffusing section and the second diffusing section. Therefore, compared with when the first diffusing section, the second diffusing section, and the light source are present on the same plane, it is possible to further increase the display region of the display section in size without increasing the wearable device in size in the side surface direction of the display section.

In the aspect of the invention, it is preferable that the wearable device includes: a substrate housed in the case section; and a pulse sensor configured to measure a pulse, the light source is fixed to one surface of the substrate, and the pulse sensor is located on another surface side of the substrate.

According to the aspect with this configuration, because the light source can be mounted on the substrate, it is possible to reduce manufacturing cost compared with when the light source is set on the first diffusing section. Because the substrate is present between the pulse sensor and the light source, it is possible to prevent stray light due to the light emitted from the light source from being made incident on the pulse sensor.

In the aspect of the invention, it is preferable that the wearable device includes a frame fixed to a side surface of the case section, and a light-source housing section configured to house the light source and a hole configured to cause the light guide section and the light-source housing section to communicate are formed in the frame.

According to the aspect with this configuration, because a light leak from the light source can be prevented by the light-source housing section, it is possible to prevent the light emitted from the light source from being made incident on a device including a light receiving section such as the pulse sensor.

In the aspect of the invention, it is preferable that the light-source housing section includes an opening on one surface side of the substrate.

According to the aspect with this configuration, because the light source can be confined by the light-source housing section and the substrate, it is possible to make it easy to assemble the wearable device while reducing a light leak from the light source.

In the aspect of the invention, it is preferable that a metal film is formed on apart of or the entire other surface.

According to the aspect with this configuration, light is totally reflected by the metal film. A light leak from the outer circumferential surface of the first diffusing section does not occur. Therefore, it is possible to efficiently guide the light emitted from the light source to the second diffusing section.

In the aspect of the invention, it is preferable that, among a plurality of surfaces forming the second diffusing section, at least one of a first surface opposed to the display section and a second surface opposed to the first surface has unevenness.

According to the aspect with this configuration, because scattered lights by the unevenness are irradiated on the display section, a user can easily visually recognize display content of the display section.

In the aspect of the invention, it is preferable that the second surface has the unevenness.

According to the aspect with this configuration, because the second surface has the unevenness, the scattered lights by the unevenness are directed to the display section. Therefore, compared with when only the first surface has the unevenness, it is possible to increase an amount of light irradiated on the display section.

### BRIEF DESCRIPTION OF THE DRAWINGS

The invention will be described with reference to the accompanying drawings, wherein like numbers reference like elements.

FIG. 1 is a perspective view of a wearable device.

FIG. 2 is a device configuration diagram of the wearable device.

FIG. 3 is a sectional view of the wearable device.

FIG. 4 is a diagram showing the structure of a front light.

FIG. 5 is a diagram showing surface roughness of the front light.

FIG. 6 is a diagram showing a range of the width of a division line of the front light.

FIG. 7 is a diagram showing a positional relation between the front light and a solar module.

FIG. 8 is a plan view of a substrate.

FIG. 9 is a bottom view of the substrate.

FIG. 10 is a plan view of the substrate and a frame built in a case section.

FIG. 11 is a sectional view around an LED.

FIG. 12 is a diagram showing a front light in a first modification.

FIG. 13 is a diagram showing a front light in a second modification.

### DESCRIPTION OF EXEMPLARY EMBODIMENTS

An embodiment is explained below. Note that the embodiment explained below does not unduly limit the content of the invention described in the appended claims. Not all of components explained in the embodiment are essential constituent elements of the invention.

### A. Embodiment

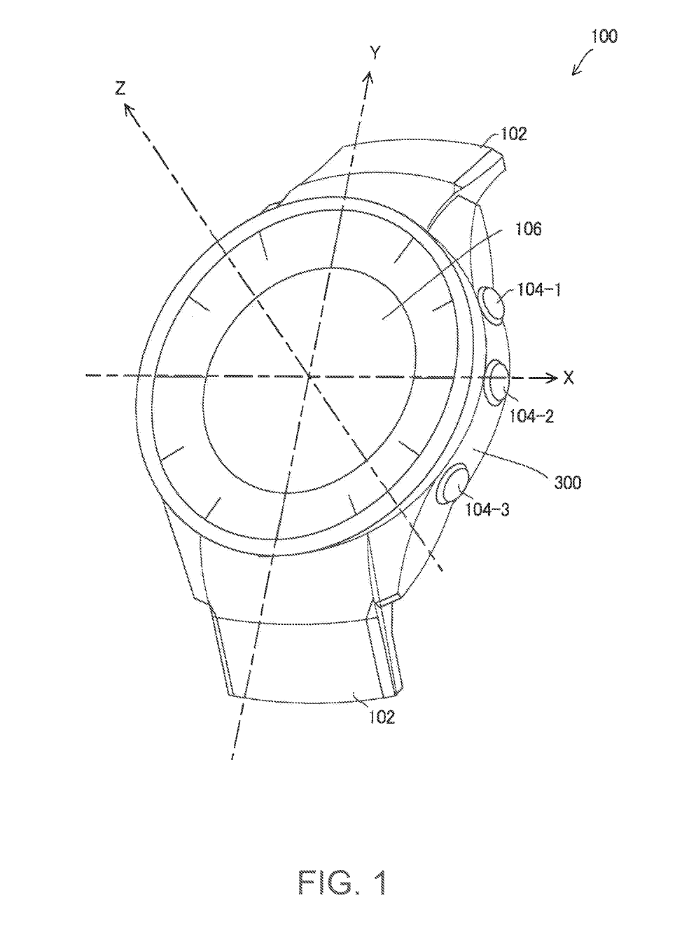

FIG. 1 is a perspective view of a wearable device 100. The wearable device 100 is a device worn on the body of a user. The wearable device 100 shown in FIG. 1 includes a band section 102, buttons 104-1 to 104-3, a display surface 106, and a case section 300. For example, the wearable device 100 is a wrist device worn on the wrist of the user. As shown in FIG. 1, the wearable device 100 has the same exterior as the exterior of a wristwatch. In FIG. 1, when the side of the display surface 106 of a display section is represented as a front surface, the direction from the rear surface to the front surface is represented as a Z-axis positive direction. Two axes orthogonal to the Z axis are represented as X and Y axes. The direction from the center of the display surface 106 to the button 104-2 is represented as an X-axis positive direction. Alternatively, the normal direction of the display surface 106 of the display section can be represented as a Z axis, the direction from the center of the display surface 106 to the band can be represented as the Y axis, and an axis orthogonal to the Z axis and the Y axis can be represented as the X axis.

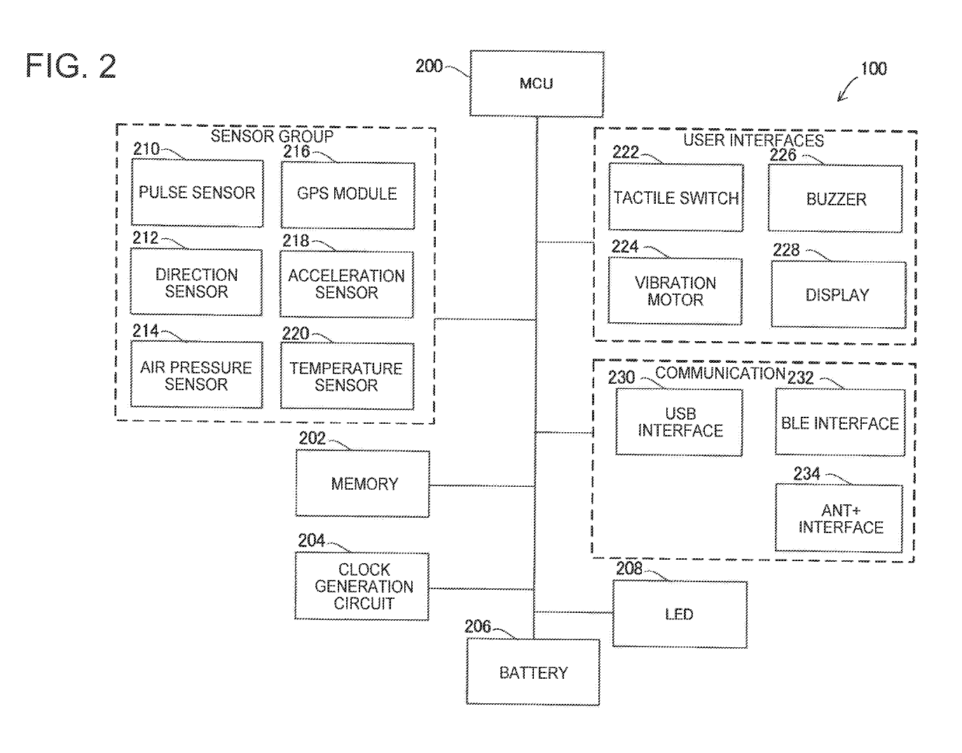

In FIG. 2, a device configuration diagram of the wearable device 100 is shown. As shown in FIG. 2, the wearable device 100 includes an MCU (Micro Control Unit) 200, a memory 202, a clock generation circuit 204, a battery 206, and a light source 208, which are electrically connected via a bus. The wearable device 100 includes, as sensor sections, a pulse sensor (a photoelectric sensor) 210, a direction sensor 212, an air pressure sensor 214, a GPS (Global Positioning System) module 216, an acceleration sensor 218, and a temperature sensor 220. The wearable device 100 includes, as user interfaces, a tactile switch 222, a vibration motor 224, a buzzer 226, and a display 228. Further, the wearable device 100 includes, as communication sections, a USB (Universal Serial Bus) interface 230, a BLE (Bluetooth (registered trademark) Low Energy) interface 232, and an ANT+ interface 234.

In this embodiment, the tactile switch 222 is an example of an “operation switch section”. In this embodiment, the display 228 is an example of a “display section”.

The MCU 200 is a control device that controls the wearable device 100. Specifically, the MCU 200 includes, on the inside, a memory that stores a computer program. The MCU 200 executes generation processing of time information, storage processing of an exercise state of the user, and moving speed calculation processing. The memory 202 includes a nonvolatile memory that stores firmware of the wearable device 100 and a working memory used by the MCU 200.

The clock generation circuit 204 generates a clock signal having a fixed frequency and supplies the clock signal to the MCU 200. The battery 206 supplies driving power to the MCU 200, the memory 202, and the like. The light source 208 is a light source that irradiates light on the display 228.

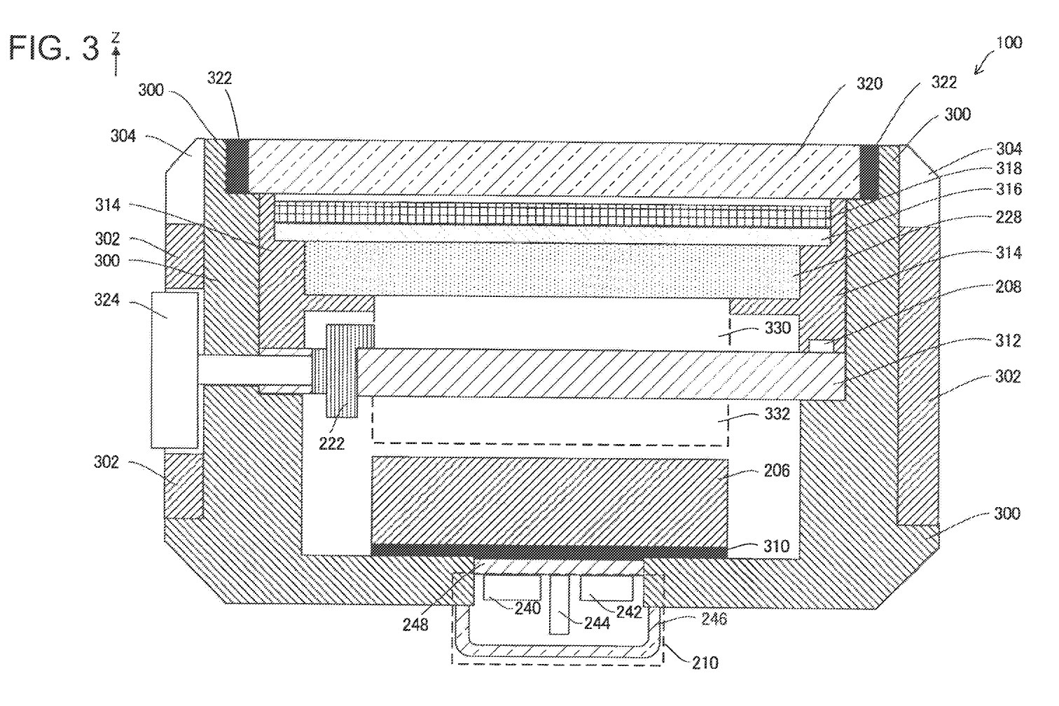

The pulse sensor 210 outputs a pulse signal. For example, the pulse sensor 210 includes a light emitting section 240 (see FIG. 3), a light receiving section 242 (see FIG. 3), a light blocking section 244 (see FIG. 3), a transparent member 246 (see FIG. 3), a band-pass filter, and an AD converter. The pulse sensor 210 is supported by a sensor substrate 248 (see FIG. 3). Light emitted from the light emitting section 240 is reflected on a tissue of a human body such as a blood vessel and made incident on the light receiving section 242. The light receiving section 242 generates a photoelectrically converted signal, that is, a pulse signal. The AD converter AD-converts a signal output by the light receiving section 242 to generate pulse signal data and outputs the generated pulse signal data to the MCU 200. A light absorption amount of the light emitted from the light emitting section 240 by hemoglobin or the like included in blood flowing in a blood vessel of a living organism changes in association with pulsation of the heart. Therefore, an amount of light made incident on the light receiving section 242 corresponds to propagation of the pulsation of the heart, that is, a pulse. The MCU 200 calculates a pulse rate, a pulse interval (an R-R interval), pulse fluctuation (HRV: Heart Rate Variability), and the like of the user on the basis of a pulse signal output from the pulse sensor 210 or pulse signal data obtained by digitally converting the pulse signal. The light blocking section 244 is a member that prevents the light emitted from the light emitting section 240 from being directly made incident on the light receiving section 242. The transparent member 246 is a transparent member that prevents inflow of foreign matters into the case section 300 while transmitting the light emitted from the light emitting section 240 to the outside. Note that at least one of a blood pressure and a blood oxygen level can be measured by selecting a wavelength of the light of the light emitting section 240 as appropriate on the basis of the same principle. The pulse sensor 210 may be referred to as photoelectric sensor section.

The direction sensor 212 measures a direction that the wearable device 100 faces. The air pressure sensor 214 measures an atmospheric pressure around the wearable device 100. The GPS module 216 includes an antenna that receives a radio wave from a satellite and a generation circuit that generates position information and GPS time information indicating a position on the basis of an output signal of the antenna. The acceleration sensor 218 measures acceleration of the wearable device 100. The temperature sensor 220 measures temperature around the wearable device 100.

The tactile switch 222 detects pressing operation by the user. For example, when a passage lap is measured, the vibration motor 224 notifies, with vibration of a motor, the user that the passage lap is measured. The display 228 displays an image based on measurement data measured by a sensor. The display 228 is a flat member on which the light emitted from the light source 208 is irradiated. As the display 228, for example, a reflection-type liquid crystal panel or a display device by electrophoresis (EPD: electrophoretic deposition) can be adopted.

The USB interface 230 is an interface conforming to a USB standard. The BLE interface 232 is an interface confirming to a BLE standard. The ANT+ interface 234 is an interface conforming to an ANT+ standard.

In FIG. 3, a sectional view of the wearable device 100 taken along a plane including the Z axis and the light source 208 is shown. FIG. 3 is equivalent to a view of the display 228 in a cross-sectional view from the normal direction of the display 228, that is, a direction orthogonal to the Z direction.

As shown in FIG. 3, the wearable device 100 includes the case section 300, a side cover 302, and a bezel 304. The wearable device 100 houses a tape 310, the battery 206, the tactile switch 222, a substrate 312, a frame 314, the display 228, a front light 316, and a solar module 318. The wearable device 100 includes a cover 320 and a gasket 322 that close an opening of the case section 300. Further, the wearable device 100 includes a button top 324 that interlocks with the tactile switch 222. Further, the wearable device 100 includes the pulse sensor 210 and the sensor substrate 248.

The case section 300 is a housing of the wearable device 100 having an opening section. Various components such as the light source 208, the tactile switch 222, the front light 316, the display 228, and the substrate 312 are housed in the case section 300. The side cover 302 is a cover attached to a side surface of the case section 300. The side cover 302 has functions of reinforcement of the strength of the case and decoration of the case. The case section 300 and the side cover 302 configure a body of the wearable device 100. The body is the side surface of the case section 300. The bezel 304 is a component that protects and reinforces the display 228 and the case section 300. The battery 206 is fixed in the case section 300 via the tape 310 having adhesiveness. On the substrate 312, hardware devices such as the MCU 200, a communication section, the memory 202, the clock generation circuit 204, the GPS module 216, the acceleration sensor 218, and the like are disposed. As shown in FIG. 3, the light source 208 is disposed on the substrate 312. The hardware devices are disposed in device regions 330 and 332 shown in FIG. 3. The frame 314 supports the display 228, the front light 316, and the solar module 318. The frame 314 is fixed in the case section 300 by the substrate 312 and the cover 322.

The front light 316 irradiates the light emitted from the light source 208 on the display 228. Because the display 228 is illuminated by the light irradiated by the front light 316, the user can easily visually recognize display content of the display 228 even in a dark environment.

As shown in FIG. 3, the display 228 is located between the front light 316 and the light source 208. As a positional relation, the light source 208, the display 228, and the front light 316 are disposed in ascending order of coordinate positions on the Z axis. As indicated by this positional relation, the front light 316 and the light source 208 are not present on the same XY plane, that is, are disposed on different planes. Therefore, the wearable device 100 is capable of including the light source 208 without increasing in size in the side surface direction of the case section 300. The front light 316 is configured by a transparent member capable of guiding light. As the material of the front light 316, for example, PMMA (Polymethyl Methacrylate (polymethyl methacrylate resin or acrylic resin), PET (polyethylene terephthalate), and PC (polycarbonate) can be used.

The solar module 318 generates electricity using the energy of light of the sun or the like. The cover 320 has a function of preventing inflow of foreign matters into the inside of the wearable device 100 from the outside and relaxing a shock applied to the wearable device 100 from the outside. The cover 320 is equivalent to a windshield in a wristwatch. As the material of the cover 320, for example, glass, acrylic resin, and polycarbonate can be used. The gasket 322 is a seal material for fixing used to impart airtightness and liquid-tightness to the wearable device 100. The button top 324 is a member that presses the tactile switch 222 when being pressed by the user. On the sensor substrate 248, the pulse sensor 210 is disposed in the Z-axis negative direction. The substrate 312 and the sensor substrate 248 are electrically connected by a flexible board (FPC: Flexible Printed Circuits), a flexible cable, or the like not shown in FIG. 3.

As shown in FIG. 3, the pulse sensor 210 is fixed to the sensor substrate 248, which is another substrate different from the substrate 312. In this case, in a cross-sectional view of the battery 206, the substrate 312, and the sensor substrate 248 from a direction orthogonal to the Z axis, the battery 206 is located between the substrate 312 and the sensor substrate 248. As shown in FIG. 3, the sensor substrate 248 is located between the battery 206 and the bottom surface of the case section 300. In other words, the sensor substrate 248 is disposed between the bottom surface of the case section 300 and the substrate 312. Alternatively, the sensor substrate 248 is disposed between the bottom surface of the case section 300 and the battery 206. The bottom surface of the case section 300 is a part of the inner wall surface of the case section 300 and is a surface opposed to a contact surface of the case section 300 in contact with the body of the user. The bottom surface of the case section 300 is, for example, a surface substantially parallel to the XY plane. Alternatively, the bottom surface of the case section 300 is an inner wall surface substantially parallel to the contact surface of the case section 300 in contact with the body of the user. In general, in the Z-axis direction, the battery 206 is thicker than the substrate 312. Consequently, when the battery 206 is present between the pulse sensor 210 and the light source 208, compared with when the substrate 312 is present between the pulse sensor 210 and the light source 208, it is possible to further prevent the light emitted from the light source 208 from being made incident on the pulse sensor 210. The battery 206 is fixed to the bottom surface of the case section 300 or the sensor substrate 248 by the tape 310.

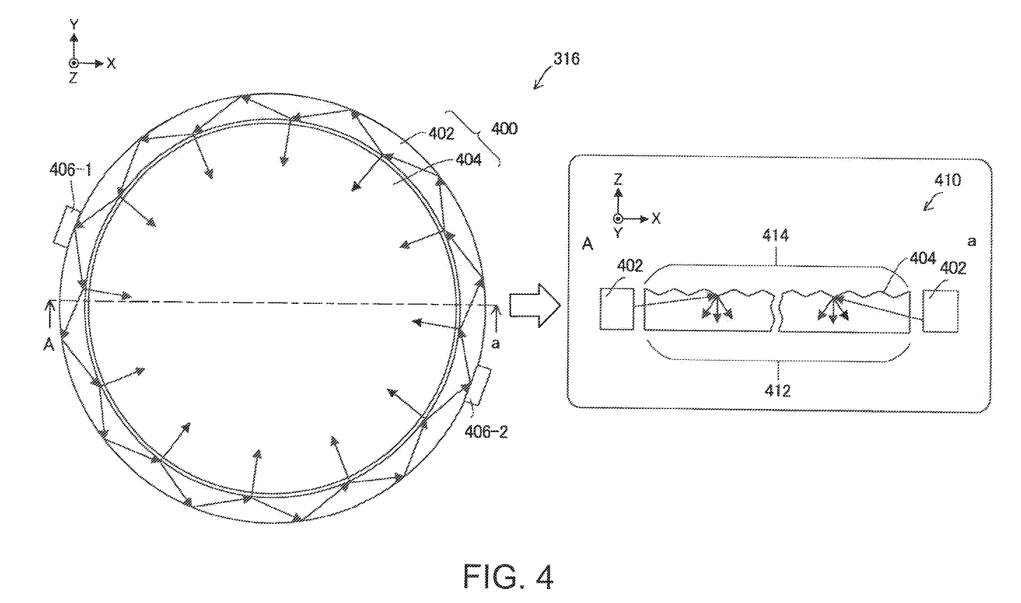

In FIG. 4, an example of the structure of the front light 316 is shown. The front light 316 shown on the left of FIG. 4 includes a diffusing section 400 that irradiates light emitted from the light source 208 on the display 228 and a light guide section 406 that guides the light emitted from the light source 208 to the diffusing section 400. The diffusing section 400 includes a first diffusing section 402 and a second diffusing section 404. The light guide section 406 includes a first light guide section 406-1 and a second light guide section 406-2. In the following explanation, when components of the same type are distinguished, reference signs are used in such a manner as “first light guide section 406-1” and “second light guide section 406-2”. When the components of the same type are not distinguished, only a common number of the reference signs is used in such a manner as “light guide section 406”.

The first diffusing section 402 is an annular member that diffuses light emitted from the light source 208. The “annular” may be any shape as long as a ring is closed. Therefore, when the shape of the inner circumference and the outer circumference of the first diffusing section 402 is a square, the shape is included in the “annular”. As shown in FIG. 4, the inner circumference and the outer circumference of the first diffusing section 402 in this embodiment are circular. A surface opposed to the second diffusing section 404 (hereinafter referred to as “inner circumferential surface of the first diffusing section 402”) among a plurality of surfaces forming the first diffusing section 402 has higher surface roughness than the other surfaces among the plurality of surfaces. The surface roughness is a degree indicating the roughness of a surface. A higher degree of the surface roughness indicates that the surface is rougher. A surface opposed to the case section 300 (hereinafter referred to as “outer circumferential surface of the first diffusing section 402”) among the plurality of surfaces forming the first diffusing section 402 is applied with mirror finishing to totally reflect light and not to allow the light to escape to the outside.

Arrows shown in the front light 316 shown on the left of FIG. 4 indicate an example of paths of light emitted from the light source 208. Because the first diffusing section 402 is annular, lights guided by the first light guide section 406-1 and the second light guide section 406-2 revolve while reflecting in the first diffusing section 402. The lights are uniformized in the first diffusing section 402. Because the surface roughness of the inner circumferential surface of the first diffusing section 402 is higher than the surface roughness of the other surfaces, more lights are scattered on the inner circumferential surface than the other surfaces. Among the scattered lights, there are lights traveling toward the second diffusing section 404. As a result, on the inner circumferential surface of the first diffusing section 402, because the surface roughness is higher than the surface roughness of the other surfaces, reflected lights decrease and refracted lights increase. The refracted lights are guided to the second diffusing section 404. With such structure of the first diffusing section 402, light guided by the light guide section 406 is guided to the second diffusing section 404 after being uniformized in the first diffusing section 402 without being directly guided to the second diffusing section 404. Therefore, it is possible to prevent luminance unevenness of the display 228 from being easily caused.

Satin treatment, unevenness treatment, or the like is applied to the inner circumferential surface of the first diffusing section 402 in order to increase the surface roughness.

The second diffusing section 404 is configured to have a circumferential length smaller than the circumferential length of the inner circumferential surface of the first diffusing section 402 and include the center of the first diffusing section 402 in a planar view from the normal direction of the display 228. In other words, the second diffusing section 404 is a member that is provided on the inside of the ring of the first diffusing section 402 and irradiates light diffused by the first diffusing section 402 on the display 228. In the following explanation, when a planar view is simply described as “planar view”, the planar view is the planar view from the normal direction of the display 228.

The light guide section 406 guides light emitted from the light source 208 to the first diffusing section 402. The use of the light guide section 406 makes it unnecessary to dispose the light source 208 on a plane including the first diffusing section 402 and the second diffusing section 404. Therefore, compared with when the first diffusing section 402, the second diffusing section 404, and the light source 208 are present on the same plane, it is possible to further increase a display region of the display 228 in size without increasing the wearable device 100 in size in the side surface direction of the display 228. Flexibility of a disposing position of the light source 208 increases. As a result, it is easy to adjust disposing positions of the devices including the light source 208. It is possible to narrow disposition intervals among the devices. It is possible to dispose the devices at high density.

A cross section 410 shown on the right of FIG. 4 is a cross section taken along an A-a line on the left of FIG. 4. To irradiate light guided to the second diffusing section 404 on the display 228, unevenness is formed on at least one of a first surface 412 opposed to the display 228 and a second surface 414 opposed to the first surface 412 among a plurality of surfaces forming the second diffusing section 404. The first surface 412 is a surface of the front light 316 opposed to a display surface of the display 228. In other words, the first surface 412 is a surface of the diffusing section 400. The second surface 414 is a surface opposed to the first surface 412. In other words, the second surface 414 is a surface on the solar module 318 side, a surface of the front light 316 disposed between the first surface 412 and the cover 320, or a surface of the diffusing section 400. With this structure, because scattered lights by the unevenness are irradiated on the display 228, the user can easily visually recognize display content of the display 228.

Further, it is desirable to provide unevenness on the second surface 414. Arrows shown in the cross section 410 indicate an example of paths of lights diffused by the first diffusing section 402. It is possible to direct the scattered lights by the unevenness to the Z-axis negative direction by providing the unevenness on the second surface 414. Therefore, compared with when the unevenness is present only on the first surface 412, it is possible to increase an amount of light irradiated on the display 228.

The light guide section 406 can be formed by bending a part of a light guide plate having a flat shape. The light guide section 406 can be molded into a curved shape in advance. Consequently, because spring-back does not occur, it is possible to stabilize the shape of the light guide section 406. The spring-back means a shape change that occurs when a component is released from a load of a form mold at the end of a molding process.

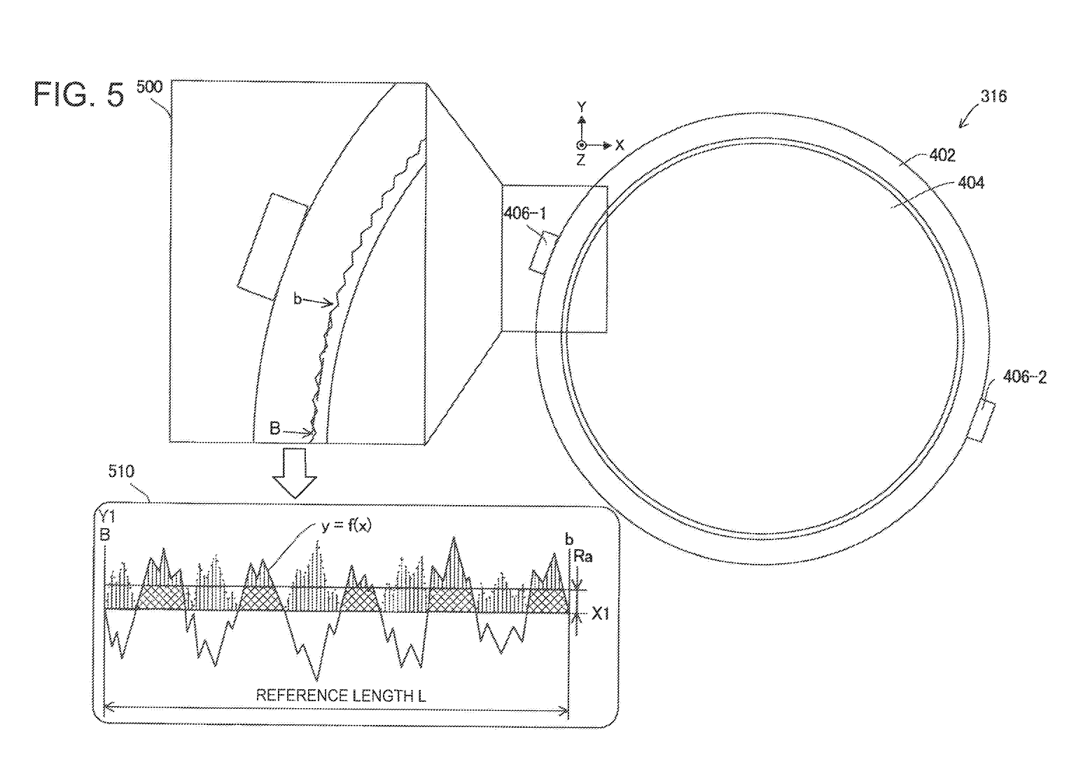

In FIG. 5, surface roughness of the front light 316 is shown. In FIG. 5, the surface roughness of the front light 316 is indicated by an enlarged region 500 obtained by enlarging the vicinity of the first light guide section 406-1. For the first diffusing section 402 to realize a ring light function for emitting uniform outer circumferential light, the inner circumferential surface of the first diffusing section 402 is formed as a scattering surface.

The lower right of FIG. 5 shows an enlarged region 510 obtained by extracting the inner circumferential surface of the first diffusing section 402 in the enlarged region 500 at a reference length B-b(L). In this embodiment, arithmetic mean roughness Ra is used as surface roughness. The reference length B-b(L) is set in a direction of an average line from a roughness curve. When a center line of the roughness curve in the direction of the average line of the enlarged region 510 is represented as an X1 axis, a Y1 axis extending perpendicularly to the X1 axis in a direction of longitudinal magnification of the roughness curve is set, and the roughness curve is represented by y=f(x), Ra is represented by the following expression.

$$Ra = \frac{1}{L} {\int }_{0}^{L} \vert f ( x ) \vert dx$$

In other words, Ra is an average of absolute values in the vertical direction of a surface in a reference length in the horizontal direction of the surface. When introduction efficiency into the second diffusing section 404 is considered, roughness Ra_out of the inner circumferential surface of the first diffusing section 402 and roughness Ra_in of a surface opposed to the first diffusing section 402 of the second diffusing section 404 (hereinafter referred to as “outer circumferential surface of the second diffusing section 404”) only have to have a relation indicated by the following Expression (1).

Ra_out≈Ra_in (1)

When Ra_out<Ra_in, scattered lights on the inner circumferential surface of the first diffusing section 402 decrease. Therefore, the introduction efficiency of light into the second diffusing section 404 decreases. Ra_out and Ra_in desirably have a relation indicated by the following Expression (2).

Ra_out>Ra_in (2)

When Expression (2) is satisfied, the surface roughness of the inner circumferential surface of the first diffusing section 402 is larger than the surface roughness of the outer circumferential surface of the second diffusing section 404. The scattered lights on the inner circumferential surface of the first diffusing section 402 increase. Therefore, it is easy to guide light to the second diffusing section 404. An example of Ra is explained. For example, Ra of glass subjected to lapping polishing as surface treatment is approximately 0.005 μm. Ra of glass not subjected to the surface treatment is approximately 0.023 μm. Ra of frosted glass subjected to blast treatment as the surface treatment is approximately 1.071 μm. Ra of plastic subjected to surface texturing as the surface treatment is approximately 20 μm. Ra of a member in an as-cast state is approximately 100 μm. The inner circumferential surface of the first diffusing section 402 and the outer circumferential surface of the second diffusing section 404 are processed by any one of the kinds of surface treatment explained above such that Ra_out and Ra_in are appropriate.

From the values of Ra in the respective kinds of surface treatment explained above, Ra_out and Ra_in are 0.02 μm or more and 100 μm or less. Further, Ra_out and Ra_in are desirably 0.5 μm or more and 30 μm or less.

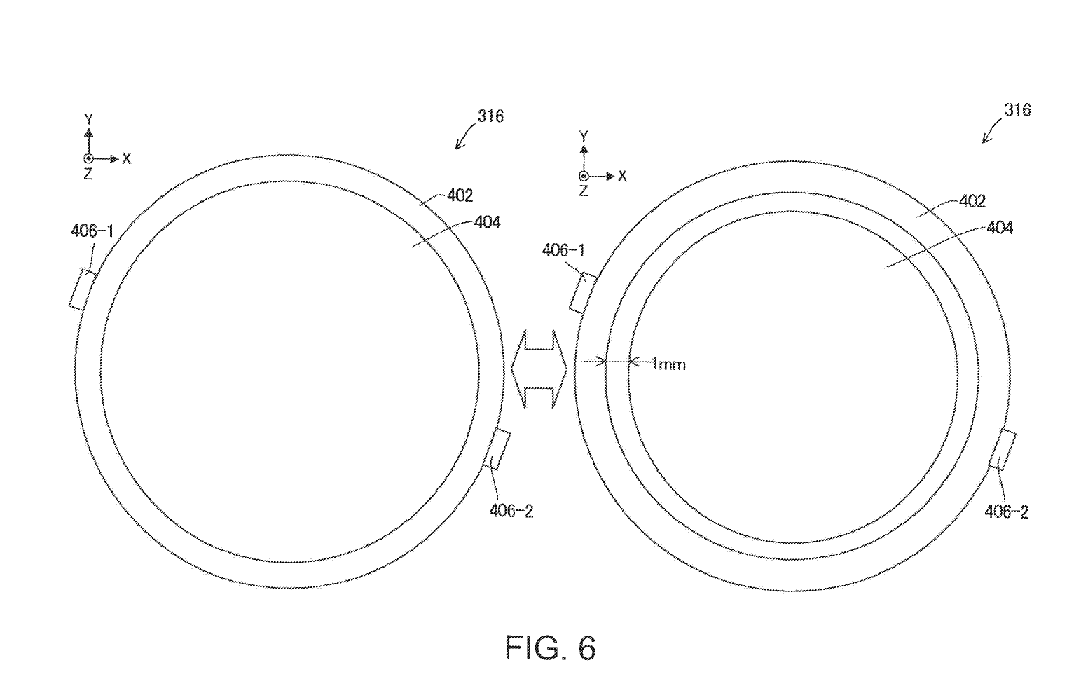

In FIG. 6, a range of the width of a division line of the front light 316 is shown. The width of the division line of the front light 316 means the width of an interval between the first diffusing section 402 and the second diffusing section 404. The front light 316 shown on the left of FIG. 6 is in a state in which the width is 0 mm, that is, the first diffusing section 402 and the second diffusing section 404 adhere. On the other hand, the front light 316 shown on the right of FIG. 6 is in a state in which the width is 1 mm. Because a light leak increases as the width is wider, the width of the division line of the front light 316 is set to 0 mm or more and 1 mm or less.

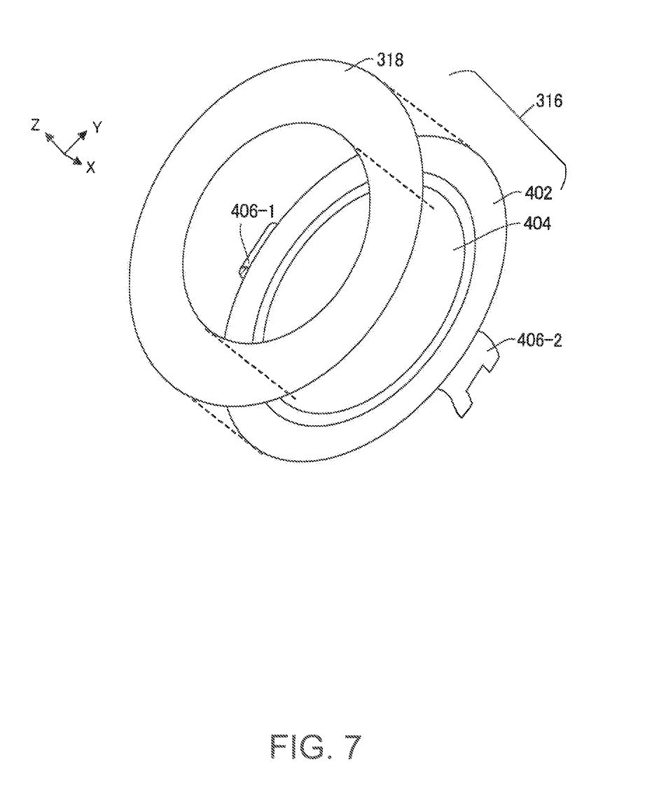

In FIG. 7, a positional relation between the front light 316 and the solar module 318 is shown. As explained with reference to FIG. 3, the solar module 318 is located in an upper part of the front light 316. As shown in FIG. 7, the solar module 318 is disposed such that the division line of the front light 316 is hidden and not seen from the user.

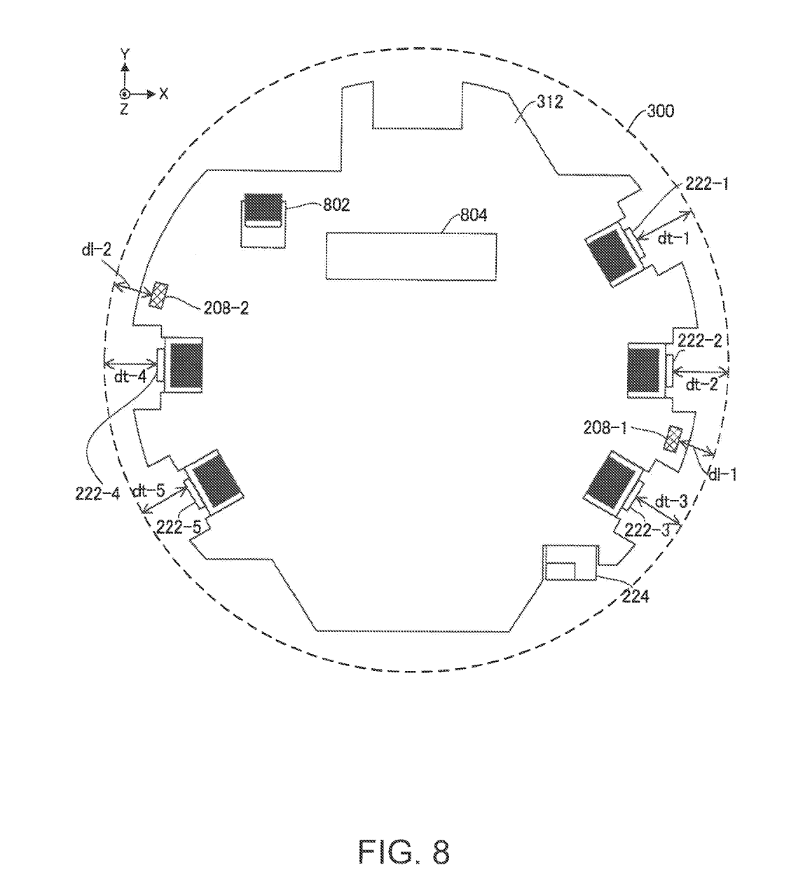

In FIG. 8, a plan view of a first surface of the substrate 312 in the planar view from the normal direction of the display 228 is shown. The first surface of the substrate 312 is a surface having a shorter distance to the display 228 of surfaces of the substrate 312 parallel to the display surface of the display 228. In other words, the first surface of the substrate 312 is a surface on which a display insertion port 804 explained below is disposed. In the following explanation, when a planar view is simply described as “planar view”, the planar view is the planar view from the normal direction of the display 228. As shown in FIG. 8, as devices that can be confirmed from the surface of the substrate 312, the substrate 312 includes light sources 208-1 and 208-2, tactile switches 222-1 to 222-5, the vibration motor 224, an insertion port 802 of the solar module 318, and an insertion port 804 of the display 228. In FIG. 8, to show a positional relation between the light sources 208-1 and 208-2 and the tactile switches 222-1 to 222-5, a line indicating the inner edge of the case section 300 is shown as a broken line. The inner edge of the case section 300 is equivalent to the inner circumferential side surface or the inner wall of the case section 300 in a planar view.

In the planar view from the normal direction of the display 228, the positions of the light sources 208 do not overlap a plurality of tactile switches 222. Therefore, it is possible to reduce the thickness in the Z-axis direction of the wearable device 100. The light sources 208 are disposed among the plurality of tactile switches 222. Therefore, it is possible to reduce the wearable device 100 in size in the X and Y directions. As a result, portability of the wearable device 100 is improved.

As shown in FIG. 8, the distances from the light sources 208 to the inner circumferential side surface of the case section 300 are shorter than the distances from all the tactile switches 222 of the plurality of tactile switches 222 to the inner circumferential side surface of the case section 300. In FIG. 8, shortest distances dl-1 and dl-2 are shown as respective distances from the light sources 208-1 and 208-2 to the inner circumferential side surface of the case section 300. Shortest distances dt-1 to dt-5 are shown as respective distances from the tactile switches 222-1 to 222-5 to the inner circumferential side surface of the case section 300. As shown in FIG. 8, dl-1 and dl-2 are shorter than all of dt-1 to dt-5. In this way, the light sources 208 are disposed at the ends of the substrate 312. It is possible to mount other devices in the center portion of the substrate 312. Therefore, it is possible to effectively utilize a mounting surface of the substrate 312. The other devices are, for example, the vibration motor 224, the insertion port 802 of the solar module 318, and the insertion port 804 of the display 228. Note that the distances from the light sources 208 to the inner circumferential side surface of the case section 300 and the distances from all the tactile switches 222 to the inner circumferential side surface of the case section 300 are not respectively limited to the shortest distances. For example, the distances from the light sources 208 to the inner circumferential side surface of the case section 300 may be set as shortest distances from the centers of the light source 208 to the inner circumferential side surface of the case section 300. The distances from all the tactile switches 222 to the inner circumferential side surface of the case section 300 may be set as shortest distances from the center of all the tactile switches 222 to the inner circumferential side surface of the case section 300.

As shown in FIG. 8, the light sources 208-1 and 208-2 are fixed to two positions on the substrate 312. In this way, because the wearable device 100 includes a plurality of light sources 208, it is possible to further reduce luminance unevenness than one light source 208 and increase luminance to improve visibility. Because the light sources 208 are disposed on the substrate 312, compared with when the light sources 208 are set in the front light 316, it is possible to reduce manufacturing cost.

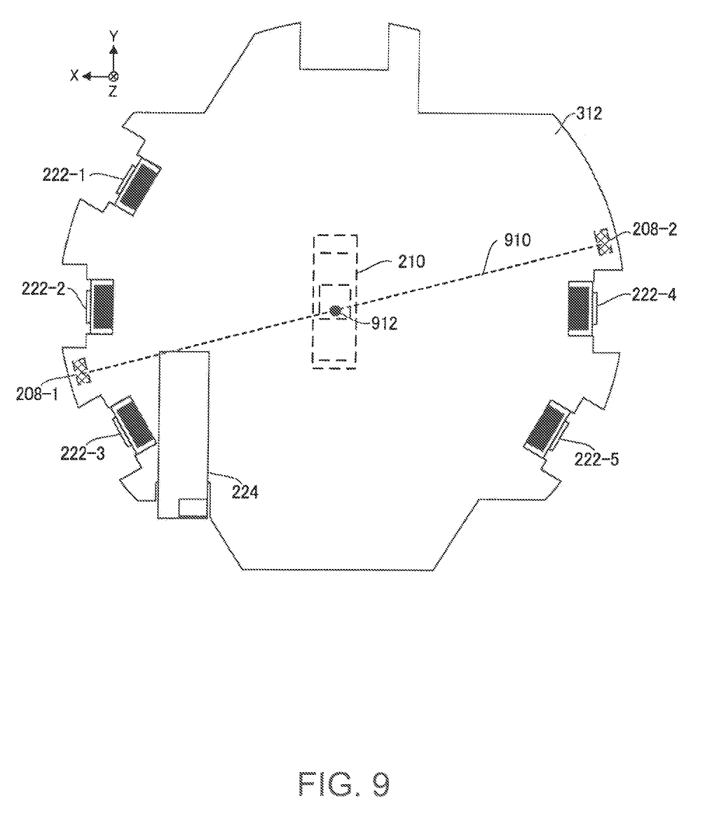

In FIG. 9, a bottom view of the substrate 312 in the planar view from the normal direction of the display 228 is shown. The bottom view of the substrate 312 is a surface on the opposite side of the first surface of the substrate 312 and is a surface having a longer distance to the display 228 of the surfaces of the substrate 312 parallel to the display surface of the display 228. The light sources 208-1 and 208-2 shown in FIG. 9 are located on the surface of the substrate 312. The pulse sensor 210 is located on the sensor substrate 248. However, in FIG. 9, to make it possible to easily confirm a positional relation, the light sources 208-1 and 208-2 and the pulse sensor 210 in a planar view are shown using broken lines.

Because the pulse sensor 210 includes the light receiving section, when the light sources 208 are present near the pulse sensor 210, an optical adverse effect that stray lights emitted from the light sources 208 are made incident on the light receiving section is likely to occur. Therefore, as shown in FIG. 9, the pulse sensor 210 is disposed on the other surface side different from one surface to which the light sources 208 of the substrate 312 are fixed. The other surface side means a region including the other surface of the substrate 312 and extending in the Z-axis negative direction (a direction from one surface of the substrate 312 toward the bottom of the case section 300).

In such a positional relation, because the substrate 312 is present between the pulse sensor 210 and the light sources 208, it is possible to prevent lights emitted from the light sources 208 from being made incident on the pulse sensor 210.

A line segment 910 shown in FIG. 9 is a line segment connecting the light sources 208-1 and 208-2 at the shortest distance. A point 912 is the center of the line segment 910. In an example shown in FIG. 9, in the planar view from the normal direction of the display 228, the point 912 coincides with the center of the display 228. In this case, the light sources 208-1 and 208-2 are located axially symmetrically with respect to an axis passing the center of the display 228. Therefore, the light sources 208-1 and 208-2 can be equally disposed with respect to the display 228. Consequently, it is possible to uniformly irradiate the display 228 with the plurality of light sources 208. The front light 316 includes the first diffusing section 402. When lights emitted from the plurality of light sources 208 are guided to the first diffusing section 402, by equally disposing the light sources 208, it is possible to more uniformly disperse the lights on the inside of the first diffusing section 402. As a result, it is possible to reduce unevenness of the lights irradiated on the display 228. In a planar view, it is desirable to dispose the point 912 to overlap the sensor substrate 248. Further, in the planar view, it is desirable to dispose the point 912 to overlap the pulse sensor 210. With such a configuration, it is possible to secure the distance between the pulse sensor 210 and the light sources 208. It is possible to reduce adverse effects of the stray lights and the like.

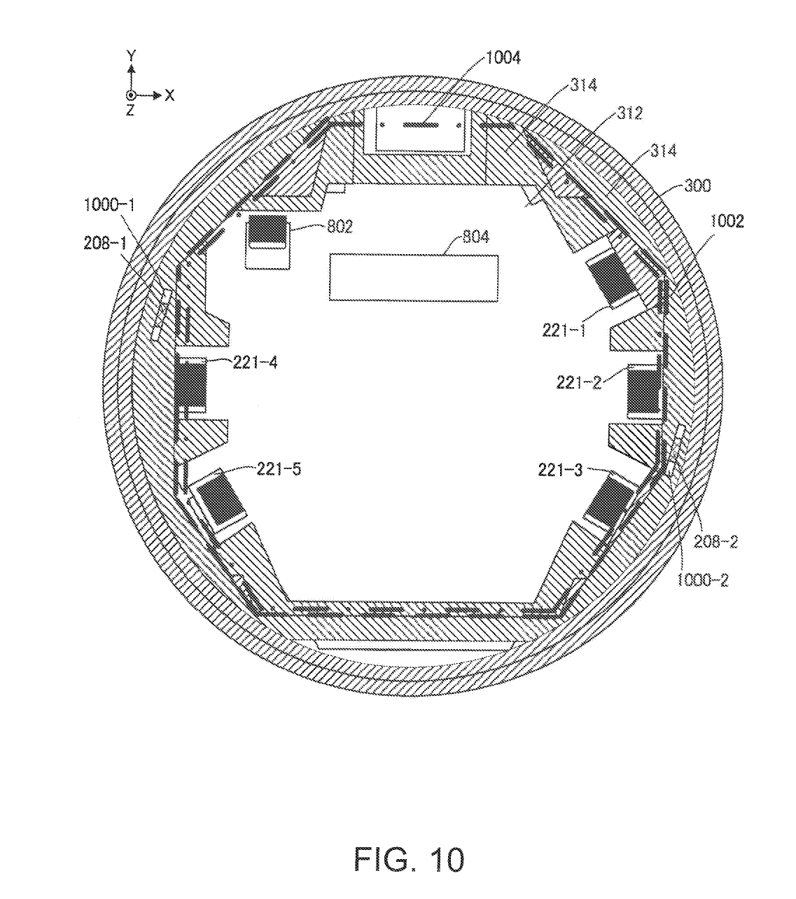

In FIG. 10, a plan view of the case section 300, in which the substrate 312 and the frame 314 are incorporated, in the planar view from the normal direction of the display 228 is shown. In the frame 314, holes 1000-1 and 1000-2 and a light-source housing section (not shown in FIG. 10) are formed. The holes 1000 are holes that cause the light guide section 406 and the light-source housing section to communicate. In FIG. 10, the light guide section 406 is not incorporated in the case section 300 yet. Therefore, in the planar view, the light sources 208 are seen from the holes 1000.

The display 228 is fit in the inner side of the frame 314. A thick alternate long and short dash line 1004 shown in FIG. 10 is a line indicating an end portion of the display 228 in a planar view. As shown in FIG. 10, the light sources 208 are located between the end portion of the display 228 and the side surface of the case section 300. Because the light sources 208 are light sources of the front light 316, if the light sources 208 are located on the inner side of the display 228, paths for guiding lights emitted from the light sources 208 are long. In this embodiment, because the light sources 208 are disposed in a gap between the end portion of the display 228 and the side surface of the case section 300, it is possible to effectively use a space. Moreover, in a planar view, the front light 316 and the light sources 208 overlap. Therefore, it is possible to increase a display area of the display 228 without increasing the diameter of a case of the wearable device 100.

As indicated by the alternate long and short dash line 1004, in a planar view, the display 228 is formed from a polygon having a plurality of linear portions. In the planar view, the light sources 208 are located between the linear portions and the case section 300. According to this positional relation, it is possible to dispose the light sources 208 in a wider space. Specifically, as shown in FIG. 10, the shape of the wearable device 100 is a circle in the planar view from the normal direction of the display 228. Therefore, the distance between the linear portions of the polygon and the side surface of the case section 300 is longer than the distance between vertexes of the polygon and the side surface of the case section 300. Therefore, according to the positional relation, it is possible to dispose the light sources 208 in a wider space.

Further, as shown in FIG. 10, a portion indicated by a thick broken line 1002 on the inner side of the frame 314 is a part of the polygon. In this way, the inner side of the frame 314 has a shape of a part of the polygon. The light sources 208 are located between sides of a part of the polygon indicated by the thick broken line 1002 and the side surface of the case section 300. According to this positional relation, it is possible to dispose the light sources 208 in a wider space. Specifically, as shown in FIG. 10, in the planar view from the normal direction of the display 228, the shape of the wearable device 100 is a circle. Therefore, the distance between the sides of a part of the polygon indicated by the thick broken line 1002 and the side surface of the case section 300 is longer than the distance between the vertexes of the polygon indicated by the thick broken line 1002 and the side surface of the case section 300. Therefore, according to the positional relation, it is possible to dispose the light sources 208 in a wider space. Note that the entire inner circumferential side surface of the frame 314 may have the shape of the entire polygon.

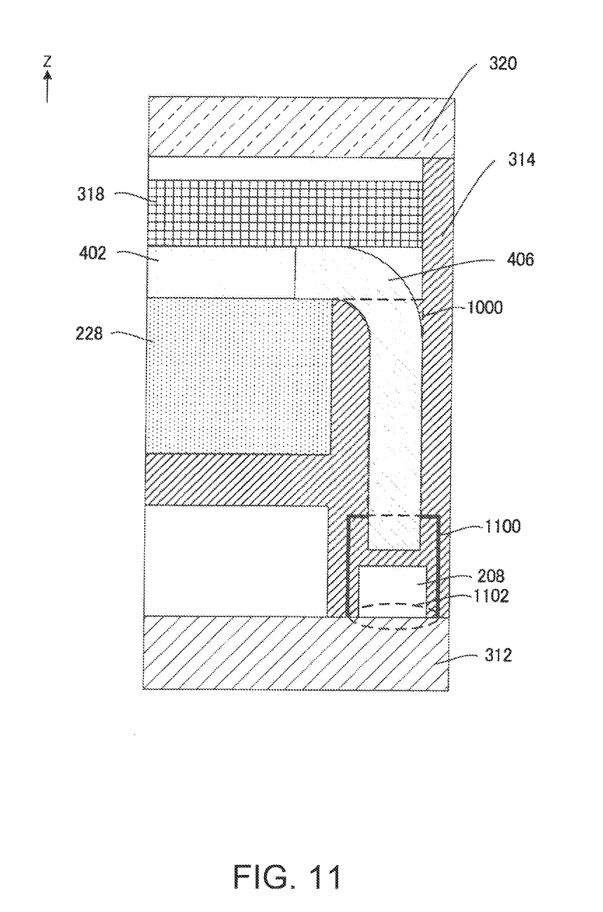

In FIG. 11, an enlarged view of the periphery of the light source 208 is shown concerning a cross section in a plane including the Z axis and including the light source 208. As shown in FIG. 11, the hole 1000 and a light-source housing section 1100 are formed in the frame 314. The light-source housing section 1100 is an enclosure that houses the light source 208. A light leak from the light source 208 can be reduced by the light-source housing section 1100. Therefore, it is possible to prevent light emitted from the light source 208 from being made incident on the pulse sensor 210.

As shown in FIG. 11, the light-source housing section 1100 includes an opening 1102 on one surface side of the substrate 312 to which the light source 208 is fixed. The frame 314 is fit into the substrate 312, the edge of the opening 1102 and the substrate 312 come into contact to confine the light source 208 in the light-source housing section 1100. In this way, the light source 208 is confined by the substrate 312 and the light-source housing section 1100. Therefore, it is possible to reduce a light leak from the light source 208. It is easy to assemble the wearable device 100 while preventing light emitted from the light source 208 from being made incident on the pulse sensor 210.

### B. Modifications

The forms explained above can be modified. Modes of the modifications are illustrated below. Two or more modes optionally selected from the following illustrations can be combined as appropriate without being in contradiction to one another. Note that, in the modifications illustrated below, components same as the components in the embodiment in actions and functions are denoted by the same reference numerals and signs as the reference numerals and signs in the above explanation. Detailed explanation of the components is omitted as appropriate.

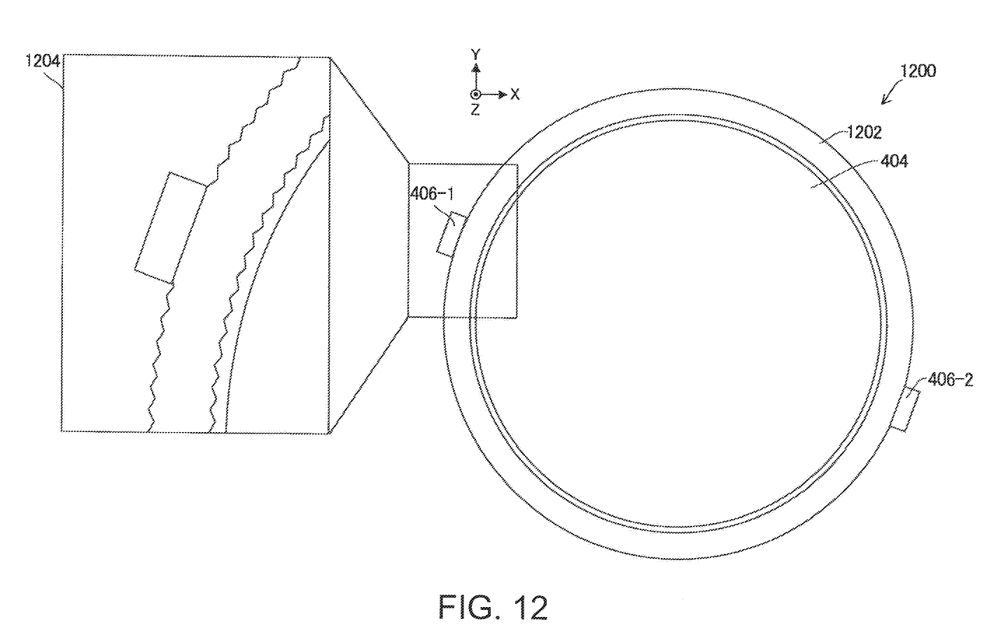

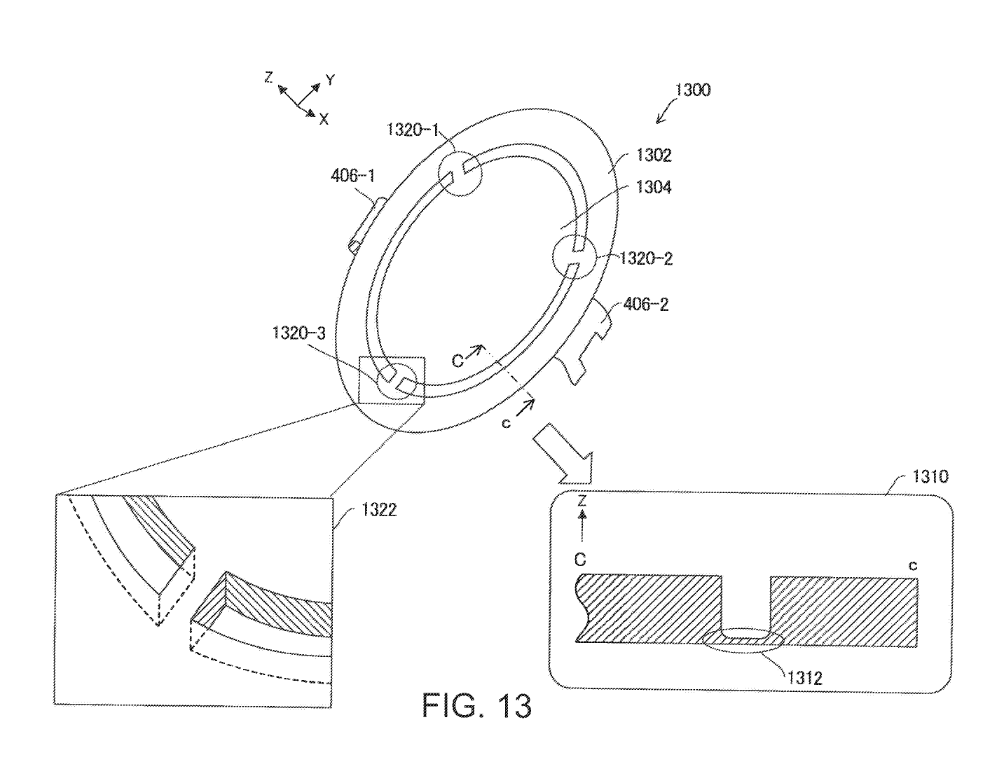

In the embodiment explained above, the front light 316 is shown in FIGS. 4 and 5 and the like. However, the front light in the invention is not limited to the front light 316. Two modifications of the front light 316 are explained below with reference to FIGS. 12 and 13.

In FIG. 12, a front light 1200 in a first modification is shown. As shown in FIG. 12, the front light 1200 has the same configuration as the configuration of the front light 316 except a first diffusing section 1202. In FIG. 12, as a part of the front light 1200, an enlarged region 1204 obtained by enlarging the vicinity of the first light guide section 406-1 is shown. As indicated by the enlarged region 1204, a satin form or unevenness is present on the outer circumferential surface of the first diffusing section 1202.

A metal film is formed in a part or the entire outer circumferential surface of the first diffusing section 1202. The metal film is formed by, for example, metal deposition. Metal is, for example, aluminum. For example, an aluminum film is formed by applying aluminum deposition to a part or the entire outer circumferential surface of the first diffusing section 1202. Consequently, even if the outer circumferential surface of the first diffusing section 1202 has the satin form or the unevenness, light is totally reflected by the aluminum film. A light leak from the outer circumferential surface of the first diffusing section 1202 does not occur. Therefore, it is possible to efficiently guide light emitted from the light source 208 to the second diffusing section 404.

In FIG. 13, a front light 1300 in a second modification is shown. The front light 1300 includes a first diffusing section 1302, a second diffusing section 1304, the first light guide section 406-1, and the second light guide section 406-2. A sectional region 1310 fractured between C and c of the front light 1300 is shown on the lower right of FIG. 13. As indicated by the sectional region 1310, the first diffusing section 1302 and the second diffusing section 1304 are not completely cut and are recessed by embossing. There is a partially connected region 1312. To provide a satin form on the inner circumferential surface of the first diffusing section 1302, for example, a surface of a die for performing the embossing pressed against the inner circumferential surface of the first diffusing section 1302 only has to have the satin form. In an example shown in FIG. 13, the region 1312 is present on the display 228 side. However, the embossing may be applied to provide the region 1312 on the solar module 318 side.

As shown in FIG. 13, in the front light 1300, the embossing is not applied to three parts of regions 1320-1 to 1320-3. By providing the parts to which the embossing is not applied, the first diffusing section 1302 and the second diffusing section 1304 are less easily separated. During assembly of the wearable device 100, it is possible to make it easy to carry the front light 1300. The number of parts to which the embossing is not applied is not limited to the example shown in FIG. 13 and may be one or may be two or more.

In FIG. 13, an enlarged region 1322 obtained by enlarging the vicinity of the region 1320 is shown. Hatched parts in the enlarged region 1322 are cross sections to which the embossing is applied.

The front light in the invention is not limited to the examples shown in FIGS. 12 and 13. For example, the front light in the invention may have structure including a third diffusing section that diffuses light diffused by the first diffusing section 402 to the inside of the ring of the first diffusing section and the outer side of the second diffusing section and guides the light to the second diffusing section 404. In this structure, annular diffusing sections are doubly disposed on the XY plane. With the structure, the light revolves in the first diffusing section 402 and the third diffusing section. Therefore, compared with the front light 316, it is possible to further uniformize the light. The first diffusing section 402 may be doubly disposed in the Z-axis direction.

In the planar view from the normal direction of the display 228, the first diffusing section 402 may be divided into a plurality of sections. The light guide section 406 is disposed on an end face of the divided first diffusing section 402. For example, the shape of the divided first diffusing section 402 is explained using the front light 316 shown in FIG. 4. The shape is a shape obtained by dividing the first diffusing section 402 with a line segment connecting the centers of the first light guide section 406-1 and the second light guide section 406-2.

The first diffusing section 402 maybe generated from a tabular member or maybe formed by curving a bar-like member to join ends of the bar-like member. The first diffusing section 402 and the second diffusing section 404 may be different from each other in the thickness in the Z-axis direction. By reducing the thickness of a part contributing to the thickness in the Z-axis direction of the wearable device 100, it is possible to reduce the thickness in the Z-axis direction of the wearable device 100. For example, in the planar view from the normal direction of the display 228, when the solar module 318 and the first diffusing section 402 have substantially the same shape, it is possible to reduce the thickness in the Z-axis direction of the wearable device 100 by reducing only the first diffusing section 402 in thickness.

The shape of the front light in the invention is not limited to the ring shape and may be a shape of a polygon such as an octagon, a square, or a triangle.

In this embodiment, the pulse sensor 210 is supported by the sensor substrate 248 different from the substrate 312. However, the pulse sensor 210 may be supported by the substrate 312. In this case, in the wearable device 100, the pulse sensor 210, the substrate 312 that supports the pulse sensor 210, the battery 206, the frame 314, the display 228, and the front light 316 are disposed in this order from the Z-axis negative direction. In this case, the pulse sensor 210 may be fixed to the other surface different from one surface of the substrate 312 to which the light sources 208 are fixed. Consequently, because the substrate 312 is present between the pulse sensor 210 and the light sources 208, it is possible to prevent lights emitted from the light sources 208 from being made incident on the pulse sensor 210. Because the pulse sensor 210 and the light sources 208 are disposed on the same substrate 312, a plurality of substrates do not have to be provided in order to set the pulse sensor 210 and the light sources 208 apart from each other. A shield formed of a conductive material may be disposed between the substrate 312, which supports the pulse sensor 210, and the battery 206. The battery 206 may be disposed on the shield via an adhesive layer such as a double-sided tape. With such a configuration, it is possible to fix the battery 206 while protecting circuit elements with the shield.

When the pulse sensor 210 is fixed to the other surface different from one surface of the substrate 312 to which the light sources 208 are fixed, the pulse sensor 210 may overlap the point 912 shown in FIG. 9. Note that, in a planar view, the center of the pulse sensor 210 and the point 912 do not always need to coincide with each other. Consequently, the pulse sensor 210 can be kept away from the light sources 208-1 and 208-2. It is possible to prevent lights emitted from the light sources 208 from being made incident on the pulse sensor 210.

One or a plurality of light sources 208 in the invention may be provided. In FIG. 9, the light sources 208 are explained as being located axially symmetrically with respect to the axis passing the center of the display 228. The invention can also be applied when more than two light sources 208 are provided. For example, if three light sources 208 are provided, the three light sources 208 only have to be respectively disposed in the positions of the vertexes of a regular triangle. If four light sources 208 are provided, the four light sources 208 only have to be respectively disposed in the positions of the vertexes of a square. As the light sources 208, the wearable device 100 may include LEDs, may include OLEDs (Organic Light Emitting Diodes), or may include other light emitting elements.

The devices shown in FIG. 2 are only an example. The wearable device 100 does not need to include all of the devices shown in FIG. 2. The wearable device 100 does not have to include the side cover 302 shown in FIG. 3.

A part to which the wearable device 100 can be attached is not limited to the wrist. For example, the wearable device 100 may be attached to other parts of the user such as an ankle. The wearable device 100 may be a HMD (Head Mounted Display) or the like. A target to which the invention is applied is not limited to the wearable device 100 and may be, for example, an electronic device. The electronic device is, for example, a car navigation device, an electric calculator, a game machine, or a video camera.

What is claimed is:

1. A wearable device comprising:
a light source;
a display;
an annular first diffusing section configured to diffuse light emitted from the light source;
a second diffusing section located on an inside of a ring of the first diffusing section and configured to irradiate the light diffused by the first diffusing section on the display; and
a case configured to house the light source, the display, the first diffusing section, and the second diffusing section, wherein
the first diffusing section includes a plurality of surfaces, and a surface opposed to the second diffusing section among the plurality of surfaces has higher surface roughness than other surfaces.

2. The wearable device according to claim 1, wherein
the display has a flat shape, and
when viewed from a direction orthogonal to a normal direction of a display surface of the display, the display is present above the light source, and the first diffusing section is present above the display.

3. The wearable device according to claim 2, further comprising a light guide section configured to guide the light emitted from the light source to the first diffusing section.

4. The wearable device according to claim 3, further comprising:
a substrate housed in the case; and
a pulse sensor configured to measure a pulse, wherein
the light source is fixed to one surface of the substrate, and
the pulse sensor is located on another surface side having a front-rear relation with the one surface of the substrate.

5. The wearable device according to claim 4, further comprising a frame fixed to a side surface of the case, wherein
a light-source housing section configured to house the light source and a hole configured to cause the light guide section and the light-source housing section to communicate are provided in the frame.

6. The wearable device according to claim 5, wherein the light-source housing section is opened on the one surface side of the substrate.

7. The wearable device according to claim 1, wherein a metal film is provided on the other surface.

8. The wearable device according to claim 1, wherein the second diffusing section includes a plurality of surfaces, and, among the plurality of surfaces, at least one of a first surface opposed to the display and a second surface opposed to the first surface has surface roughness.

9. The wearable device according to claim 8, wherein the second surface has the surface roughness.
